(19) United States
(12) Patent Application Publication
(10) Pub. No.: US 2005/0216406 A1
(43) Pub. Date: Sep. 29, 2005

(54) International bank cash system (business method)

(76) Inventor: Gabriel Ohiochioya Obadan, Pasadena, CA (US)

Correspondence Address: GABRIEL OHICHIOYA OBADAN, 677 DEL MONTE STREET, PASADENA, CA, 91103, US

(21) Appl. No.: 10/810,545

(22) Filed: Mar. 29, 2004

(51) Int. Cl. G06F 17/60

(52) U.S. Cl. 705/42; 705/43; 705/45

(57) ABSTRACT

The International Bank Cash System is an Internet-based business method that enables its users to directly withdraw money from their bank accounts or any other accounts from their personal computers and electronically transfer the amount (value) withdrawn onto new financial instruments called “Bank Cash” currencies which can be downloaded and printed from any personal computer printer and used to purchase goods and services from a network of “Registered Merchants” worldwide.

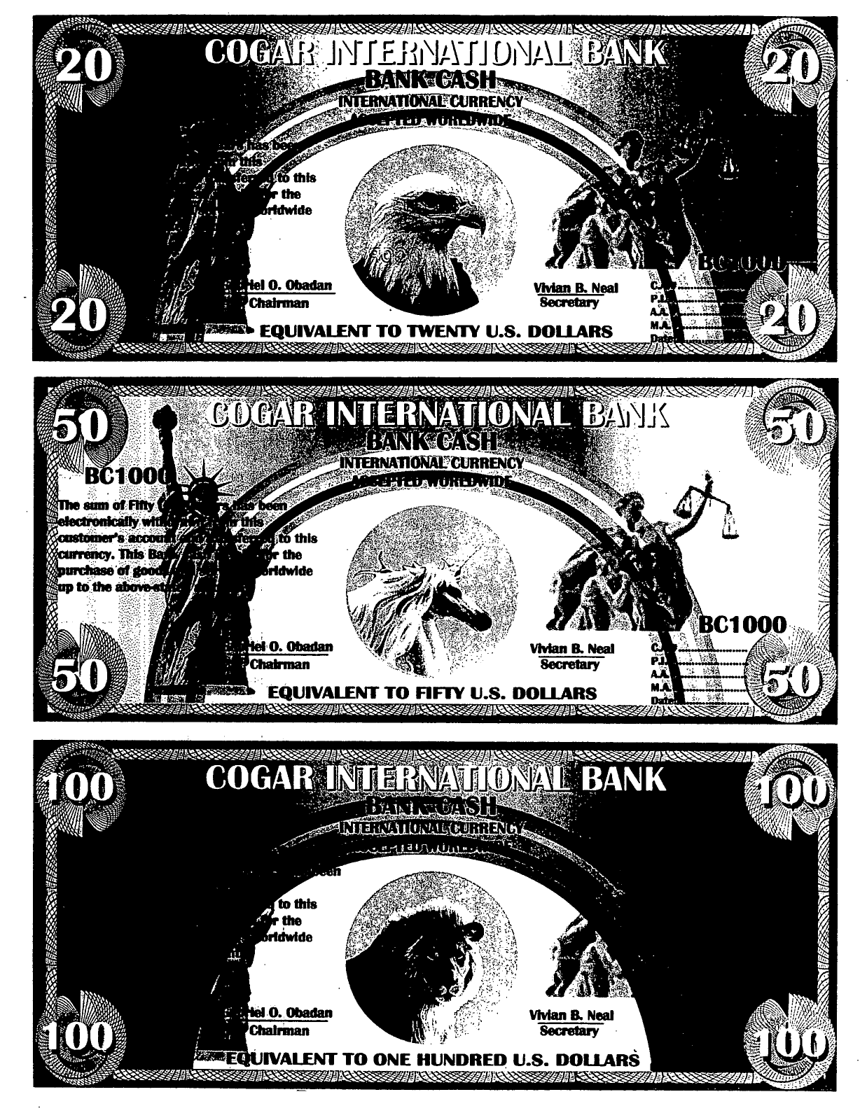

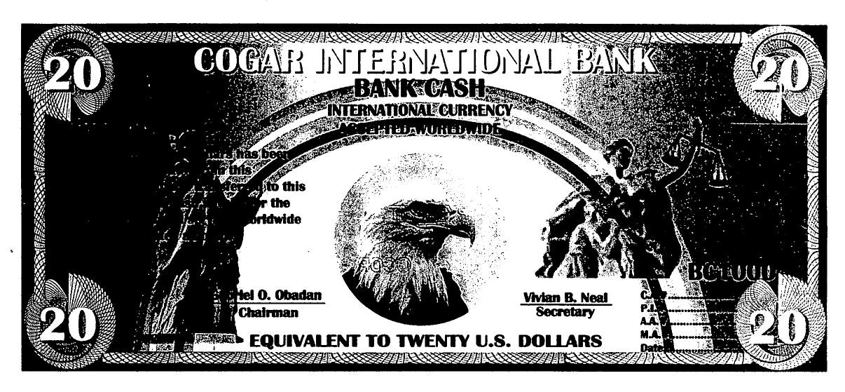

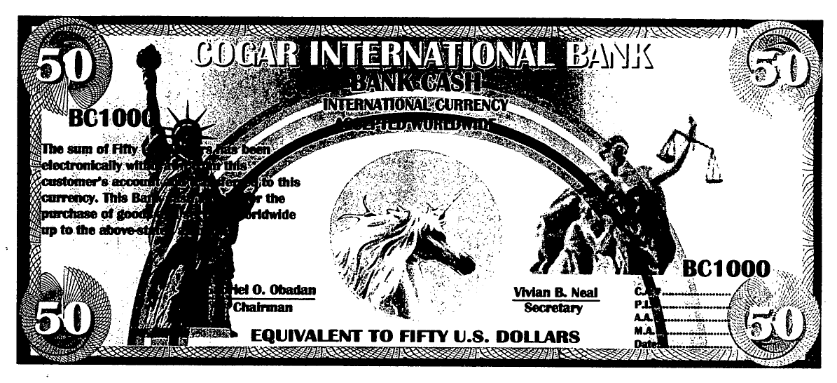

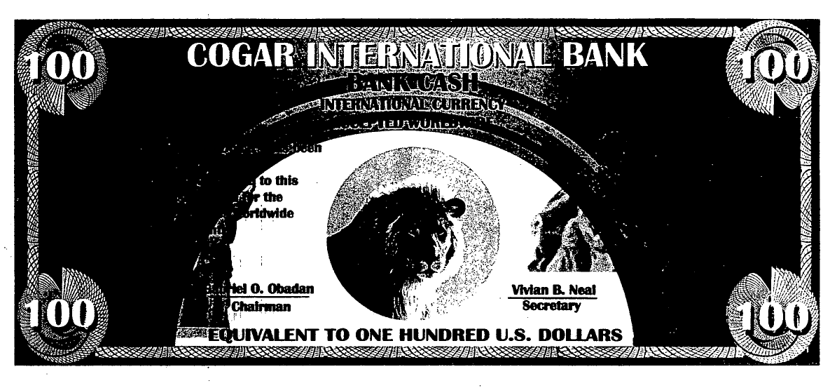

“International Bank Cash System” is an Internet-based method of doing business which allows its users to electronically access their bank accounts, credit card accounts and other investments accounts and download and print “money” called “Bank Cash” currencies which can be used to purchase goods and services from any Registered Merchant authorized to cash the “Bank Cash” currencies. For example if a user is sitting in front of his or her personal computer or any other electronic device at home, office, hotel or any public or private building, and wishes to withdraw the sum of $100 (One Hundred U.S. Dollars) from his or her checking account from his or her bank the user will first have to log onto our website with the URL of www.cogarbank.com. The user then fills out an electronic Registration Form to register as our customer and upon that, the user is given a customer account number and a personal identification number (P.I.N.). A “Bank Cash” currency in the equivalent amount of $100 (One Hundred U.S. Dollars) is then printed with its own unique currency number and date of issue, and e-mailed to the user/customer who then downloads and prints the “Bank Cash” currency and uses it to purchase any goods or services from any of our Registered Merchants worldwide.

Both the worldwide users/customers and the Registered Merchants sign up for free at our website by filling out a one-time separate electronic Registration Forms.

A user can be in any part of the world and from any location access their bank accounts through any personal computer or electronic device and print the “Bank Cash” currencies in any local denominations. The design of the “Bank Cash” currencies are standard for any country worldwide but the value of each currency is structured to correspond to the local currency value of each country and the name of the local currency is used for the “Bank Cash” currencies for that country. The user also can download and print the “Bank Cash” currencies in any international denomination and use if for foreign exchange.

For example, a U.S. tourist in France can use any available personal computer or other electronic device and access his or her bank account in the United States or any other country in the world through the www.cogarbank.com website, and withdraw $100 (One Hundred U.S. Dollars) from his or her bank account and a “Bank Cash” currency equivalent to $100 will be printed in French Francs, say 500 Francs, and the user can then download and print “Bank Cash” currency to the value of 500 French Francs and use the money to buy goods and services from any Registered Merchant in France without the need to go to the local foreign currency exchange office. This applies to all users/customers in all countries worldwide.

This convenient access to have money ready and printed from any personal Computer printer or electronic printing device whether at home, office, factory, hotels airports, schools and other public or private buildings, enable the computer to automatically become an equivalent to the current A.T.M. (Automated Teller Machine) and enables the user to avoid going to banks and A.T.Ms. to stand in long lines to withdraw their money. The “Bank Cash” currencies now make it easy and convenient to withdraw “cash” from any personal computer or electronic device at home office or other locations without the need to go out in bad weather to the local bank or A.T.M.

The user of the “International Bank Cash System” can also send money (Bank Cash) from their accounts to friends and relatives worldwide, receive money (Bank Cash) from anyone from any part of the world, pay bills, salaries, buy foreign exchange and invest in foreign exchange transactions, without leaving the comforts of their homes or offices, all from any personal computer or electronic device. The Registered Merchant signs on with our bank called “Cogar International Bank, Inc.” for free and is authorized to receive and cash the “Bank Cash” currencies and give change in the local currency to the holder of the “Bank Cash” currencies for a percentage fee (profit). The Registered Merchant, upon being presented with a “Bank Cash” currency (in any denomination e.g. $20, $50, or $100) will first call our Toll-free telephone number and ask the customer to write out their customer number, personal identification number (P.I.N.) and the authorization number before accepting the “Bank Cash” currency. If the three numbers do not match, the Registered Merchant is authorized to refuse or reject the “Bank Cash” currency. Each transaction by the user is monitored by the “International Bank Cash System” computer program and the user's bank account number and routing number are used to electronically gain access to his or her account and equivalent amount plus fees are withdrawn and automatically transferred to our bank reserve account from which the Registered Merchant is paid electronically as soon as the transaction is completed (from the time of printing the “Bank Cash” currency until it is cashed and change is given to the customer by the Registered Merchant).

The user or customer can also obtain personal or small business loans and advances, printed in “Bank Cash” currencies from their computers it they qualify.

Cogar International Bank, Inc. the bank that operates the “International Bank Cash System” on the world wide web (Internet), charges each user or customer a “Transaction Fee” for each transaction and a monthly “Administrative Fee” and pays its Registered Merchants a Processing Fee” for each received and cashed “Bank Cash” currency.

### FIELD OF THE INVENTION (BUSINESS METHOD)

The “International Bank Cash System” relates to business on the Internet (E-Commerce) that involves the electronic withdrawal and transfer of money (funds) from one account and transcription of the value onto financial instruments called “Bank Cash” currencies which can be downloaded and printed from any personal computer printer both domestically and internationally.

It covers the broad area of E-Commerce involving banking, financial instruments, foreign exchange, funds transfer, sending and receiving money, payment of funds, loans and cash advances and international currencies.

It is a newly developed system that enables its users to conduct important banking activities from their personal computers from the comfort of their homes and offices without the need to physically go to their banks or A.T.M. locations to withdraw funds. “Money” can now be downloaded and printed from any personal computer printer.

### PRIOR ART

The known prior art are in the following areas:
1. Bank checks that can be printed from computers and used to make transaction payments.
2. Stamps that can be downloaded and printed from computers and used to send mail.
3. Tickets that can be printed from computers and used to attend events.
4. Western Union electronic funds transfer over the Internet worldwide.
5. Commercial banks' online banking services.

### BACKGROUND OF THE INVENTION

Most people leave their homes and offices in order to go to the bank or A.T.M. locations to withdraw money for whatever purposes. Valuable time is spent in long lines at the bank waiting to withdraw funds during the daytime and at night, risky trips are taken to an A.T.M. location to make cash withdrawals.

To solve these problems and to provide maximum convenience and security for people with bank accounts and other types of accounts, the “International Bank Cash System” was created to enable anyone with a personal computer, at home or at the office, access their bank accounts day and night and withdraw any amount they wish and download and print the equivalent of the amount withdrawn onto financial instruments called “Bank Cash” currencies from their personal computer printers and use the “Bank Cash” currencies to purchase goods and services from a network of “Registered Merchants” authorized to cash the “Bank Cash” currencies in their local area, within their country and internationally.

1. A method of doing business on the World Wide Web (Internet) in the field of Electronic Commerce (E-Commerce) which allows users to electronically withdraw money from their bank, credit or debit card accounts, or any other accounts, directly from their personal computers from home, office or any other location and have the equivalent amount withdrawn sent to their E-mail addresses and downloaded and printed on financial instruments known as “Bank Cash” currencies or by any other name and use the currencies to purchase goods and services locally or worldwide from a network of “Registered Merchants” authorized to cash the currencies.

2. A system of international funds transfer that does not involve moving money from country to country but rather a separate individual account is maintained in each country of the world and a user in the U.S.A. can send money (in U.S. dollars) to a friend or relative in Italy, for example, and the funds are paid through a reserve account in Italy and the Italian equivalent amount is transferred onto “Bank Cash” currencies in Italian Lira, from one personal computer in the U.S.A. to another personal computer in Italy and currencies are similarly sent via E-mail and downloaded and printed from country to country worldwide.

3. A business method on the Internet that allows a user to electronically send money “Bank Cash” directly to friends and relatives world wide from his or her personal computer to their personal computers and the recipient can receive the money “Bank Cash” through his or her E-mail address and download and print the currencies from their personal computer or any other electronic printers.

4-14. (canceled)
